(19) United States
(12) Patent Application Publication
(10) Pub. No.: US 2016/0128343 A1
(43) Pub. Date: May 12, 2016

(54) Method For Producing A Baked Product Having An Essentially Sealed Separating Surface

(71) Applicant: HAAS FOOD EQUIPMENT GMBH, Wien (AT)

(72) Inventors: JOHANNES HAAS, WIEN (AT); JOSEF HAAS, LEOBENDORF (AT); STEFAN JIRASCHEK, KOENIGSBRUNN (AT); KARL TIEFENBACHER, WIEN (AT)

(21) Appl. No.: 14/897,436

(22) PCT Filed: Jun. 2, 2014
(86) PCT No.: PCT/EP2014/061312

§ 371 Date: Dec. 10, 2015

(30) Foreign Application Priority Data
Jun. 10, 2013 (AT) A 467/2013

(51) Int. Cl. A21D 13/00

(52) U.S. Cl. CPC A21D 13/008; A21D 13/0009; A21D 13/0006

(57) ABSTRACT

A method for producing a baked product includes producing a baked product preform having a substantially closed baking surface and an open-pore separating surface, applying a liquid to pasty hardenable mass to the separating surface, optionally applying the liquid to pasty hardenable mass to pores being open to the separating surface, pressing the separating surface covered with the mass onto a temperature-controlled surface, and sealing the separating surface by actively, thermally hardening the mass on the temperature-controlled surface. The baked product made from the baked product preform and the hardened mass is removed from the temperature-controlled surface.

The invention relates to a method for producing a baked product comprising the following steps: producing a baked product preform that has a substantially closed baked surface and an open pore separating surface; applying a liquid to pasty, hardenable mass to the separating surface; optionally introducing the liquid to pasty, hardenable mass into the pores that are open to the separating surface; pressing the separating surface that is provided with the mass onto a surface that is maintained at a controlled temperature; sealing the separating surface by active thermal hardening of the mass on the surface that is maintained at a controlled temperature; removing the baked product that is formed from the baked product preform and the hardened mass from the surface that is maintained at a controlled temperature.

In particular, the invention relates to a method for producing a baked product in which an open pore surface is sealed and/or reinforced.

### FIELD OF THE INVENTION

Many leavened baked goods have two characteristic elements:
1. a substantially closed and smooth surface caused by the formation of a crust during baking,
2. a porous inner structure which is due to leavening by raising agent gases and steam.

Examples thereof are baked goods from the sector bread, pastries or fine bakery products, where by forming a baked skin and gelatinization of the starch by means of steam and hot air, a closed, frequently also smooth and glossy surface crust is formed having completely different properties to the soft porous crumb in the interior.

Further examples with significant structural differences between surface and core region are waffle baked goods baked under pressure such as flat wafers, hollow waffles and wafer containers. Here, in the direct contact with the hot baking mold, baking on to the mold occurs immediately during the filling of the baking mold and formation of a baked skin appearing substantially closed, whereas the wafer interior, owing to extensive steam leavening, has a particularly open and porous structure, which is due to the water content of wafer batters which is particularly high in comparison to other baked goods, at 55 to 66%. This not very dense, large-pore inner structure is also responsible for the very low density of flat wafers, hollow waffles and wafer containers, which is only approximately 0.15 g/cm³.

If it is necessary, in the course of further processing of leavened baked products, to divide them by means of separating cuts, in the cut region the open porous structure is completely visible. This clearly also has less favorable technological properties than the closed outer skin such as, for instance, a greatly increased crumbling or fracturing, or a rapid absorption of liquid or pasty components when such components are combined with the cut open baked good rim. A further unfavorable property is the inclusion of air, in such a manner that during the coating with warm glazings, as a result of thermal expansion, the bubble that is formed bursts, which leaves behind an unattractive hole in the coating. As a result, a substantial protective function of such coatings, minimizing the ingress of atmospheric oxygen and/or moisture, is significantly reduced.

The invention relates in particular to a method for sealing such open large-pore cut edges and methods for the industrial application thereof in the case of baked good bodies formed by separating operations.

The production of baked wafers as flat wafer sheets, hollow waffle sheets, wafer cups or wafer cones in closed metal baking molds having steam venting openings has long been prior art. All of these products have in any case 2 characteristic features in common.
1. a substantially closed baked skin on all outer sides,
2. a substantially homogeneous waffle thickness in the range of continuously about 0.5 mm to about 5 mm, the latter when the continuous core region, which is typically 0.5 to 2 mm thick, is extended by engravings.
Re 1. A closed baked skin on the outer sides, or an open large-pore rim,

The products obtained during wafer baking have a smooth closed baked skin on all sides, also on the narrow rims, at all events with small openings, which mark the steam escape openings. These products therefore all have a baked, and thus closed, rim.

In addition, for instance for the production of waffle pralines, in the course of the years methods have become established in which, after the baking of the hollow waffle sheets, the baked connection between the hollow shapes remaining as waffle half shells is removed by either horizontal cutting, grinding, chamfering, planing, or by vertical punching or sawing out. The resultant waffle half shells then have an open, large-pore rim comprising the whole waffle cross section in the separation region without the closed baked skin. Such open rims are, firstly, visually unattractive. Secondly, they of course have less favorable technological properties than the closed outer skin. For instance a greatly increased crumbling or fracturing or a rapid absorption of liquid or pasty components, when such components are combined with the cut open baked good rim. In addition, the inclusion of air, in such a manner that during the coating with warm glazings, as a result of thermal expansion, the bubble that is formed bursts, which leaves behind an unattractive hole in the coating. As a result, a substantial protective function of such coatings, minimizing the ingress of atmospheric oxygen and/or moisture before the use-by date, is significantly reduced.

For economic reasons, this second technique of open rims is widespread, since the individual baking of hollow waffle shells with closed rims, in comparison with baking in hollow waffle sheets, requires a great number of individual baking molds, which gives rise to a significantly higher capital cost and space requirement.
Re 2. Homogeneous waffle thickness having 1 to 2 mm core region, up to 5 mm total thickness via engraving

The waffle (sheet) thickness also establishes the size of the open rim. A homogeneous thickness is prior art, but individual sides can be made thinner. A baked connection in a standard thickness, however, is considered essential for removing the high water fractions of 55 to 65% in the waffle batters as steam. The waffle material that is situated in the waffle sheet between the hollow waffle half shells is considered to be the baked connection.

The invention relates in particular to a method for sealing open separating surfaces or rims of hollow waffle half shells subsequently to the horizontal removal of the baked connection.

It is an object of the invention to provide a method for producing a baked product that has a sealed and/or reinforced separating surface. In particular, it is an object of the invention that the method permits an efficient industrial mass production of baked products having a reinforced and/or sealed separating surface.

The object according to the invention is achieved by the features of the independent claim. In particular, a method according to the invention comprises the following steps:

producing a baked product preform that has a substantially closed baked surface and an open pore separating surface;
applying a liquid to pasty, hardenable mass to the separating surface;
optionally introducing the liquid to pasty, hardenable mass into the pores that are open to the separating surface;
pressing the separating surface that is provided with the mass onto a surface that is maintained at a controlled temperature;
sealing the separating surface by active thermal hardening of the mass on the surface that is maintained at a controlled temperature;
removing the baked product that is formed from the baked product preform and the hardened mass from the surface that is maintained at a controlled temperature.

And optionally:

thoroughly baking a waffle molded body in a baking iron, wherein the waffle molded body comprises a plurality of baked product preforms and at least one baked connection joining the baked product preforms;
separating the baked product preforms from the baked connection along the separating surfaces of the baked product preforms;

Further features can be that the surface is actively maintained at a controlled temperature and in particular is actively heated or actively cooled, that the surface has a temperature which differs from the ambient temperature, which differs from the temperature of the mass and/or which differs from the temperature of the baked product preform, wherein the temperature is meant just before pressing of the preform onto the surface.

In addition, it can be provided according to the invention that the surface is a closed pore surface, and in particular a metal surface, that the surface is a smooth surface, that the baked product preform is separated from the baked connection and the separating surface is formed by cutting, grinding, chamfering, planing, vertical punching, sawing out, breaking or slicing, that the separating surface is a planar surface, and in particular a plane, that the mass is a solids-rich mass which is applied in layer form, in particular in a single layer, or in a thin layer, to the separating surface, that the separating surface is then sealed by guided pressing onto the heated surface at a heating temperature in the range 105° C. to 225° C., that the depth of penetration of the mass into the separating surface, and in particular into the pores of the separating surface, is less than 1 mm, that the surface is oiled before the pressing, and/or that the solids-rich mass is or contains one of the following masses:
batters for oblaten wafers, optionally with addition of coloring foods such as, e.g., cocoa, dyes, pigments and increased lipid fractions such as fats and waxes,
batters for waffles, optionally with addition of coloring foods such as, e.g., cocoa, dyes, pigments and increased lipid fractions such as fats and waxes,
masses having the main components water, starch-rich flours and/or native and/or modified food starches,
sugar-rich waffle batters as are used for preparing cast sugar cones, rolled sugar cones, sugar wafer rolls or wafer sticks,
a mixture of one of the abovementioned masses having equally viscous or similarly viscous masses A and/or B in the ratio 99:1 to 50:50, wherein masses of the type A contain dextrins of the group starch dextrins, maltodextrins, thin-boiling flours or starches, oxidized starches, and wherein masses of the type B contain modified starches of the group of starch esters and starch ethers, wherein longer-chain hydrophobic side chains such as, for instance, octenyl succinate are also included.

In addition, it can be provided that the mass is a fat-rich mass, in that the fat-rich mass is applied in layer form, in particular in a single-layer form or in a thin layer to the separating surface, that the separating surface is sealed by guided pressing onto the cooled surface under controlled low relative atmospheric humidity, that the depth of penetration of the mass into the separating surface and in particular into the pores of the separating surface is less than 1 mm, that the pressing onto the cooled surface under controlled low relative atmospheric humidity proceeds in a closed station, that the fat-rich mass is and/or contains chocolate, compound chocolate, fat glaze, or ice cream glaze, and/or that subsequently, preferably immediately subsequently, the baked product is coated, filled, covered with a spread and/or dipped.

The invention also relates to a baked product comprising a baked product preform having a substantially closed surface and an open pore separating surface, wherein the open pore separating surface is closed by a hardenable and hardened mass.

In particular, modifications to the physical properties of the masses as described in the exemplary embodiments are designated as hardening.

In particular, modifications to the physical properties at the separating surface as described in the exemplary embodiments are designated as sealing.

As a result of the method and/or sealing according to the invention, the following purposes are achieved:
1. The baked product, e.g. the waffle half shell, is provided with a visually attractive, smooth or patterned rim.
2. The separating surface is mechanically stabilized. Breaking off of thin ridges of the separating surface and in particular on the open rim (crumbling), associated with the loss/restriction of the service properties is eliminated.
3. The penetration of moisture and atmospheric oxygen through the open pore separating surface is prevented.
4. The baked products, e.g. the waffle half shells, are also usable as individual products or individual containers. This is possible without a combining adhesion of two half shells at the open rims, in such a manner that, as is known, the half shells need not, at all events, be joined by using an edible adhesive such as, for instance, fat-sugar masses, or chocolate, in order to achieve the effects cited in 1. to 3.

In the method according to the invention, the open pore separating surface of a baked product preform is sealed. For this purpose a pasty, in particular liquid to viscous, hardenable mass is applied to the separating surface. This application takes place in a layered manner, and in particular as a single layer as a thin layer.

The process in which an open pore surface is closed by a substantially closed pore layer is designated as sealing. This closed pore layer, however, is not necessarily air- or liquid-tight. However, it has a structure which has smaller pores than the open pore separating surface.

Subsequently thereto, the baked product preform is pressed onto a surface that is maintained at a controlled temperature together with the mass that is applied to the separating surface. The surface that is maintained at a controlled temperature is constructed, for example, as a smooth or structured metal surface. In particular, preferably, those materials and top surfaces of the surface are used in which no adhesion of the pasty hardenable mass occurs. Optionally, by coating the surface with oil, the tendency to adhesion can be decreased. The surface is preferably made of metal, for example of cast iron, tempered or not tempered, or made of stainless steel. In addition, the surface is actively maintained at a controlled temperature. That is to say that the surface is either heated or cooled. In particular, the surface has a temperature which differs from the ambient temperature. For hardening the mass, the surface, furthermore, preferably has a temperature which differs from the temperature of the mass on application to the separating surface. According to a particularly preferred embodiment, the temperature of the surface also differs from the temperature of the baked product preform during or shortly before the pressing operation.

The mass is hardened by the surface that is maintained at a controlled temperature. As a result, the separating surface is sealed. This hardening takes place, for example, along a smooth surface. By pressing on the baked product preform and the mass, the mass penetrates into the open pores of the separating surface of the baked product preform.

In this case, the pressing may be performed in such a manner that the peaks of the open pore separating surface are closed flush with the mass in the hardened state.

According to a further embodiment, the mass can cover the open pore separating surface completely in such a manner that a layer of the mass lies over the entire separating surface. Open pore parts of the separating surface are completely covered thereby.

The method according to the invention forms a baked product that possesses an outer casing that is completely substantially closed or sealed. Those surfaces of the baked product which are in contact with one of the waffle baking plates during the thorough baking have in any case a substantially closed small-pore outer skin. The separating surfaces that are formed by a separating operation open the porous crumb of the baked product preform to the outside. In particular, these separating surfaces are sealed, reinforced and closed by the method according to the invention. A baked product is formed thereby that comprises a baked product preform that has a substantially closed top surface and an open pore separating surface, wherein the open pore separating surface is closed by a hardenable mass. Examples of such products are hollow waffles, in particular half shells, which are formed by separating them off from a baked aggregate. In particular, these separated baked product preforms have a separating surface which substantially corresponds to a planar surface. For sealing, as a result, the surface onto which the preform is pressed can also be made planar.

Hereinafter, the method according to the invention will be discussed in more detail with reference to two specific exemplary embodiments.

First exemplary method: sealing (closing the open rim) via a baking step after application of solids-rich masses
a. The application of a solids-rich mass in aqueous solution or suspension in a thin layer onto the open rim. The expression solids-rich mass designates a solids content of 20% and more, preferably of 34% or more, particularly preferably of 40% or more. This application preferably proceeds in a step by known methods of application of thin layers of viscous solutions and suspensions, preferably by means of brushing, roller application or stripping in the contact method.
b. The composition of the solids-rich mass extends from conventional batters for oblaten wafers and waffles, optionally with addition of coloring foods such as, e.g., cocoa, dyes, pigments and increased lipid fractions such as fats and waxes. Main components are, in addition to water, therefore starch-rich flours of all types and also food starches (native and/or modified).
c. The said “conventional batters for oblaten wafers and waffles” explicitly include sugar-rich waffle batters as are used for preparing cast sugar cones, rolled sugar cones, sugar wafer rolls or wafer sticks. The fractions of sugars, optionally of sugar substitutes, present therein here, as is known from the technology of sugar wafers, lead to the formation of a sugar glass after cooling, which reduces moisture diffusion and increases in a desirable manner the mechanical strength of such sealing rims.
d. In order to achieve two preferred properties of such sealings, glossiness and increased hydrophobic properties, the masses described under b. are mixed with identical-viscosity or similar-viscosity masses A and/or B in the ratio 99:1 to 50:50. Masses of type A contain dextrins of the group starch dextrins, maltodextrins, thin-boiling flours or starches, oxidized starches. Masses of type B contain modified starches of the group of starch esters and starch ethers, wherein longer-chain hydrophobic side chains such as, for instance octenyl succinate are also explicitly included. If the properties of the masses A and B permit, fractions higher than 50% of A and/or B are also employable, in individual cases up to 100%.
e. The application rate is dimensioned in such a manner that moisture penetration of the open rim via the entrained water fractions remains below 1 mm, preferably below 0.5 mm, particularly preferably below 0.3 mm—at a lower water fraction of the solids-rich mass, therefore, more can be applied than at a higher fraction.
f. Immediately after application of the solids-rich mass, by pressing onto a heated metal plate or baking plate, the rim is sealed by baking with a smooth or patterned design, depending on the plate design. The sealing temperature of the heated plates is in the range from 105° C. to 225° C., preferably 135° C. to 205° C., particularly preferably 160° C. to 205° C.
g. The sealing operation proceeds in a sealing station which follows immediately the step of separating off the baked connection of the hollow waffle sheet. Separating off the baked connection proceeds by known methods. The separated half shells with an open rim are here pressed, mechanically guided or held, onto the hot sealing plate which comes into contact beneath, above, and optionally also at the side. The pressing operation can proceed from the half shelf guide or from the sealing plate, preferably from the former. The sealing plate is heated by one of the methods known for baking molds, but preferably electrically or electrically by induction. Oiling and also scrapping off baked residues, or cleaning, the heated sealing plate, is optionally integrated into the sealing station.
h. The duration of the sealing operation is in the range from 1 to 60 seconds, preferably 6 to 50 seconds. This duration will be adapted by a person skilled in the art to the amount of supplied solids and supplied water. The criterion is that more than 50% of the supplied water, preferably more than 70%, particularly preferably more than 90%, exits from the sealing zone and that on the sealing top surface, the gelatinization of the fraction of gelatinizable starch is approximately 100%.
i. Subsequently to the hot sealing station, there follow immediately the subsequent process steps such as, for example, coating, metering, brushing or dipping.

In principle, the sealing method is also applicable to conventionally baked hollow bodies or baked goods having a porous crumb if, as a consequence of separating off a part of the closed baked skin, an open pore structure occurs.

### Method 1: Method Scheme

| | |
|---|---|
| 1 | Baking a hollow body or a sheet having a plurality |
| | of hollow bodies having a baked connection, or |
| | baking a baked good having a porous crumb. |
| 2 | Separating off the baked connection with methods of |
| | the prior art and flat-holding/guiding the |
| | remaining baked good body or separating off a part |
| | of the baked good with porous crumb and |
| | holding/guiding. |
| 3 | Applying the solids-rich mass in a thin layer by |
| | known methods. Depth of penetration less than 1 mm. |
| 4 | Immediate thermal sealing by guided pressing onto a |
| | heated top surface which can optionally be oiled. |
| | Heating temperature in the range 105° C. to 225° C. |
| 5 | Further process steps, for instance coating, |
| | metering, brushing, dipping, etc. immediately |
| | subsequently. |

Second exemplary method: Sealing (closing the open rim) via a cooling step after application of fat-containing masses.
a. Application of a free-flowing, molten fat-rich mass of the group chocolate, compound chocolate, fat glaze, ice cream glaze, in a thin layer onto the open rim. This application preferably proceeds in a step by known methods of application of thin layers of viscous solutions and suspensions, preferably by means of stripping in the contact method, roller application, dipping or brushing. The color of the mass is as desired. The optional application of a plurality of colored masses is included.
b. The temperature of the baked good body is held in such a manner that the free-flowing molten fat-rich mass does not significantly change the temperature thereof and thereby the solids fraction up to hardening.
c. The amount applied is dimensioned by a person skilled in the art in such a manner that a closed sealing layer is formed without gaps or visually disturbing projections.
d. Immediately after application of the fat-rich mass, by pressing onto a cooled metal plate having a smooth or patterned form, depending on plate design, the smooth, glossy sealing surface is formed. The precautions known from the above explained technology with respect to control of atmospheric humidity and temperature must be maintained within this working range. These parameters are likewise adapted by those skilled in the art just as is the contact time, to the small amount of fat-rich mass that is to be solidified. In particular, the temperature of the fat-rich mass must be brought below the melting point of the mass, preferably rapidly.
e. This cold sealing operation proceeds in a sealing station which follows immediately the step of separating off the baked connection of the hollow waffle sheet. Separating off the baked connection proceeds by known methods. The separated half shells with an open rim and applied fat-rich mass are here pressed, mechanically guided or held, onto the cold stamping plate which comes into contact beneath, above, and optionally also at the side. The pressing operation can proceed from the half-shell guide or from the cold stamping plate, but preferably from the former.
f. Subsequently to the cold sealing station, the subsequent pressing operations for the rim-sealed hollow waffle half shells can follow immediately, such as, for example, coating, metering, brushing or dipping.

The cold sealing method is also applicable to conventionally baked hollow bodies or baked goods having a porous crumb if, as a consequence of separating off a part of the closed baked skin, an open pore structure occurs.

Recipe Examples of Fat-Containing Masses

TABLE 1
True chocolates

| | Milk A | Milk B | White | Dark A | Dark B |
|---|---|---|---|---|---|
| Cocoa mass | 12 | 12 | 0 | 33 | 48 |
| Cocoa butter | 20 | 23 | 24 | 15 | 9.5 |
| CBE | 1.5 | 0 | 3.5 | 0 | 0 |
| Sugars | 46 | 40.5 | 48 | 51.5 | 42 |
| Whole milk powder | 20 | 7 | 22 | 0 | 0 |
| Skimmed milk powder | 0 | 7 | 0 | 0 | 0 |
| Milk sugars | 0 | 5 | 2 | 0 | 0 |
| Whey powder | 0 | 5 | 0 | 0 | 0 |
| Minor components, | 0.5 | 0.5 | 0.5 | 0.5 | 0.5 |
| approx. | | | | | |
| Fat fraction, | 33.5 | 33.5 | 33.5 | 33 | 35 |
| approx. | | | | | |
| FP, ° C., approx. | 34 | 33 | 34 | 35 | 35 |

CBE . . . Cocoa butter equivalent
Minor components . . . emulsifiers (lecithin, PGPR), vanillin (flavoring)
FP . . . fusion point/melting point

TABLE 2
True chocolates

| | | | Ice | Ice | Ice |
|---|---|---|---|---|---|
| | Milk | | cream | cream | cream |
| | chocolate | Milk | glaze, | glaze, | glaze, |
| | dip | coating | white | milk | dark |
| Cocoa mass | 13 | 15 | 0 | 12.5 | 32.5 |
| Cocoa butter | 13 | 18 | 32.5 | 27.5 | 20 |
| CBE | 4 | 4.5 | 0 | 0 | 0 |
| Sugars | 49 | 41 | 40 | 40.5 | 41 |
| Whole milk powder | 14.5 | 0 | 22 | 14 | 0 |
| Skimmed milk | 0 | 8 | 0 | 0 | 0 |
| powder | | | | | |
| Pure butter fat | 0 | 7 | 5 | 5 | 6 |
| Whey powder | 6 | 6 | 0 | 0 | 0 |
| Minor components, | 0.5 | 0.5 | 0.5 | 0.5 | 0.5 |
| approx. | | | | | |
| Fat fraction, | 29 | 38 | 43.5 | 43.5 | 44 |
| approx. | | | | | |
| FP, ° C., approx. | 34 | 33 | 33 | 33 | 34 |

CBE . . . Cocoa butter equivalent
Minor components . . . emulsifiers (lecithin, PGPR), vanillin (flavoring)
FP . . . fusion point/melting point

TABLE 3
Compound chocolate masses

| | Milk | Dark | White |
|---|---|---|---|
| | compound | compound | compound |
| Cocoa mass | 0 | 5 | 0 |
| Cocoa powder | 5 | 14 | 0 |
| Cocoa butter | 0 | 0 | 0 |
| CBE | 0 | 0 | 0 |
| CBR | 32.5 | 31.5 | 30 |
| CBS | 0 | 0 | 0 |
| Sugars | 45 | 49 | 43.5 |
| Whole milk powder | 0 | 0 | 16 |
| Skimmed milk | 12 | 0 | 5 |
| powder | | | |
| Pure butter fat | 0 | 0 | 0 |
| Whey powder | 5 | 0 | 5 |
| Minor components, | 0.5 | 0.5 | 0.5 |
| approx. | | | |
| Fat fraction, | 33.5 | 36 | 34.5 |
| approx. | | | |
| FP, ° C., approx. | 35 | 35 | 35 |

CBE . . . Cocoa butter equivalent
CBR . . . Cocoa butter replacer
CBS . . . Cocoa butter substitute (lauric)
Minor components . . . emulsifiers (lecithin, PGPR), vanillin (flavoring)
FP . . . fusion point/melting point

TABLE 4
Compound fat glaze masses

| | Fat | Fat | | Ice cream |
|---|---|---|---|---|
| | glaze | glaze | Ice cream | glaze |
| | milk | dark | glaze milk | dark |
| Cocoa mass | 0 | 0 | 0 | 0 |
| Cocoa powder | 5 | 12 | 5 | 10 |
| Cocoa butter | 0 | 0 | 0 | 0 |
| CBE | 0 | 0 | 0 | 0 |
| CBR | 0 | 0 | 0 | 0 |
| CBS | 29 | 31.5 | 35 | 36 |
| Sugars | 44 | 49 | 42.5 | 47.5 |
| Whole milk powder | 9 | 0 | 12 | 0 |
| Skimmed milk | 7.5 | 0 | 0 | 0 |
| powder | | | | |
| Pure butter fat | 0 | 0 | 5 | 6 |
| Whey powder | 5 | 7 | 0 | 0 |
| Minor components, | 0.5 | 0.5 | 0.5 | 0.5 |
| approx. | | | | |
| Fat fraction, | 32 | 33 | 44 | 44 |
| approx. | | | | |
| FP, ° C., approx. | 33 | 33 | 25 | 26 |

CBE . . . Cocoa butter equivalent
CBR . . . Cocoa butter replacer
CBS . . . Cocoa butter substitute (lauric)
Minor components . . . emulsifiers (lecithin, PGPR), vanillin (flavoring)
FP . . . fusion point/melting point

### Method 2: Method Scheme

| | |
|---|---|
| 1 | Baking a hollow body or a sheet having a |
| | plurality of hollow bodies having a baked |
| | connection, or baking a baked good having a |
| | porous crumb. |
| 2 | Separating off the baked connection with methods |
| | of the prior art and flat-holding/guiding the |
| | remaining baked good body or separating off a |
| | part of the baked good with porous crumb and |
| | holding/guiding. |
| 3 | Applying the fat-rich mass in a thin layer by |
| | known methods to the open rim surfaces at a |
| | controlled temperature also of the baked good. |
| 4 | Immediate cold sealing by the known cold |
| | stamping technology by guided pressing onto a |
| | cooled top surface in a closed station with |
| | controlled low relative atmospheric humidity. |
| 5 | Further process steps, for instance coating, |
| | metering, brushing, dipping, etc. immediately |
| | subsequently. |

1-18. (canceled)

19. A method for producing a baked product, the method comprising the following steps:
a. producing a baked product preform having a substantially closed baked surface and an open pore separating surface;
b. applying a liquid to pasty hardenable mass to the separating surface;
c. optionally introducing the liquid to pasty hardenable mass into pores being open to the separating surface;
d. pressing the separating surface provided with the mass onto a temperature-controlled surface;
e. sealing the separating surface by active thermal hardening of the mass on the temperature-controlled surface; and
f. removing the baked product formed from the baked product preform and the hardened mass from the temperature-controlled surface.

20. The method according to claim 19, which further comprises producing the baked product by performing the following steps:
a. providing a waffle molded body having a plurality of baked product preforms and at least one baked connection joining the baked product preforms;
b. thoroughly baking the waffle molded body in a baking iron; and
c. separating the baked product preforms from the at least one baked connection along the separating surfaces of the baked product preforms.

21. The method according to claim 19, which further comprises actively maintaining the surface at a controlled temperature by actively heating or actively cooling.

22. The method according to claim 19, which further comprises setting a temperature of the surface being different than at least one of an ambient temperature, a temperature of the mass or a temperature of the baked product preform just before being pressed onto the surface.

23. The method according to claim 19, wherein the surface is a closed pore surface or a metal surface.

24. The method according to claim 19, wherein the surface is a smooth surface.

25. The method according to claim 20, which further comprises separating the baked product preform from the at least one baked connection and forming the separating surface by cutting, grinding, chamfering, planing, vertical punching, sawing-out, breaking or slicing.

26. The method according to claim 19, wherein the separating surface is a planar surface or a plane.

27. The method according to claim 19, which further comprises:
applying the mass to the separating surface as a solids-rich mass in layer form or as a single layer or as a thin layer; and
subsequently sealing the separating surface by guided pressing onto the surface being heated at a heating temperature in a range of from 105° C. to 225° C.

28. The method according to claim 27, which further comprises penetrating the mass into the separating surface or into the pores of the separating surface to a depth of less than 1 mm.

29. The method according to claim 27, which further comprises oiling the surface before the pressing step.

30. The method according to claim 27, wherein the solids-rich mass is or contains one of the following masses:
i. batters for oblaten wafers, optionally with an addition of coloring foods or cocoa, dyes, pigments and increased lipid fractions or fats or waxes,
ii. batters for waffles, optionally with an addition of coloring foods or cocoa, dyes, pigments and increased lipid fractions or fats or waxes,
iii. masses having as main components water and at least one of starch-rich flours or native or modified food starches,
iv. sugar-rich waffle batters as are used for preparing cast sugar cones, rolled sugar cones, sugar wafer rolls or wafer sticks,
v. a mixture of one of the masses i.-iv. having equally viscous or similarly viscous masses of at least one of a type A or a type B in a ratio of 99:1 to 50:50,
the masses of the type A containing dextrins selected from the group of starch dextrins, maltodextrins, thin-boiling flours or starches, oxidized starches,
the masses of the type B containing modified starches of the group of starch esters and starch ethers, and
including longer-chain hydrophobic side chains or octenyl succinate.

31. The method according to claim 19, wherein:
the mass is a fat-rich mass;
the fat-rich mass is applied in layer form or in a single-layer form or in a thin layer to the separating surface; and
the separating surface is sealed by guided pressing onto the surface being cooled under controlled low relative atmospheric humidity.

32. The method according to claim 31, which further comprises penetrating the mass into the separating surface or into the pores of the separating surface to a depth of less than 1 mm.

33. The method according to claim 31, which further comprises carrying out the pressing onto the cooled surface under controlled low relative atmospheric humidity in a closed station.

34. The method according to claim 31, wherein the fat-rich mass is or contains chocolate, compound chocolate, fat glaze, or ice cream glaze.

35. The method according to claim 19, which further comprises subsequently or immediately subsequently at least one of coating, filling, covering with a spread or dipping the baked product.

36. A baked product, comprising:
a baked product preform having a substantially closed top surface and an open pore separating surface; and
a hardenable and hardened mass closing said open pore separating surface.
